(19) United States
(12) Patent Application Publication
(10) Pub. No.: US 2006/0206433 A1
(43) Pub. Date: Sep. 14, 2006

(54) Secure and authenticated delivery of data from an automated meter reading system

(75) Inventor: Sean M. Scoggins, Raleigh, NC (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Elster Electricity, LLC.

(21) Appl. No.: 11/078,979

(22) Filed: Mar. 11, 2005

(51) Int. Cl. H04L 9/00

(52) U.S. Cl. 705/63

(57) ABSTRACT

Digital signatures are applied to metered energy data that is collected by a common data collection system. The system receives data from meters that may be owned by one or more utilities. The data is stored by the system using public key cryptography to ensure that it is only accessible by the intended consumer of the data. When the data is transmitted to the intended consumer, it is digitally signed by the system to ensure the authenticity of the data as received by the consumer.

### FIELD OF THE INVENTION

The present invention relates in general to the field of electrical power distribution systems. More particularly, the present invention relates to the secure, authenticated aggregation and delivery of metered and/or energy information.

### BACKGROUND OF THE INVENTION

In today's society, it is becoming more and more desirable to transmit digital information from one location to another in a manner which is clear and unambiguous to a legitimate receiver, but incomprehensible to any illegitimate recipients. Accordingly, such information is typically encrypted by a software application executing some predetermined encryption algorithm and is transmitted to the legitimate receiver in encrypted form. The legitimate receiver then decrypts the transmitted information for use.

Often, encryption/decryption of information is accomplished through symmetric key cryptography. The cryptographic security of data encrypted using symmetric key cryptography depends on the security provided for the key used to encipher and decipher the data. Thus, one of the major difficulties with such cryptographic systems is the need for the sender and receiver to exchange a single key in such a manner that an unauthorized party does not have access to the key.

Another method of encryption/decryption is to use two separate keys (referred to as a “key pair”) in which a first key (“a public key”) of the key pair is used for encryption of a message from a legitimate sender while a second key (“a private key”) of the key pair is used by the legitimate receiver for decryption of the message. This method is commonly referred to as “asymmetric” (or public) key cryptography. One advantage of asymmetric key cryptography is that it alleviates the burdensome key management problem associated with symmetric key cryptography. However, in such communications system, it is known that an illegitimate entity (e.g., commercial spy) may attempt to impersonate a legitimate entity (e.g., employee) by sending fraudulent messages to another legitimate entity for the purpose of disrupting work flow or obtaining confidential information. Thus, additional protocols are usually used in the asymmetric key system to ensure message and sender authentication.

With a public key system, it is possible to communicate privately without transmitting any secret keys. The public key system does require that an encryption/decryption key pair be generated. The encryption keys for all users may be distributed or published and anyone desiring to communicate simply encrypts his or her message under the destination user's public key. Only the destination user, who retains the secret decrypting key, is able to decipher the transmitted message.

A major problem in public key and other cryptographic systems is the need to confirm that the sender of a received message is actually the person named in the message. An authenticating technique known utilizing “digital signatures” allows a user to employ his secret key to “sign a message” which the receiving party or a third party can validate using the originator's public key. Recipients of the message can verify the message or signature by encrypting it with the sender's public encryption key. Thus, the digital signature process is essentially the reverse of the typical cryptographic process in that the message is first decrypted and then encrypted.

Serious problems still persist in public key cryptosystems of assuring that a specified public key is that actually created by the specified individual. One known technique for addressing this problem is to rely on some trusted authority, e.g., a governmental agency, to insure that each public key is associated with the person who is claiming to be the true author.

The trusted authority creates a digital message which contains the claimant's public key and the name of the claimant (which is accurate to the authority's satisfaction) and a representative of the authority signs the digital message with the authority's own digital signature. This digital message, often known as a certificate, is sent along with the user of the claimant's own digital signature. Any recipient of the claimant's message can trust the signature, provided that the recipient recognizes the authority's public key (which enables verification of the authority's signature) and to the extent that the recipient trusts the authority.

Conventional electrical power distribution systems exchange data between individual meters and a remote site, such as a central processing office. Typically, a password is exchanged between the remote site and the meter at the beginning of a session, and the assumption is made that the session is not altered thereafter. Thus, when the meter transmits data, it is making the assumption that the communication channel is directly connected to the remote site and only to the remote site. Likewise, the remote site assumes it is communicating with the actual meter.

Various techniques are used for uniquely authenticating a remote site or meter. For example, passwords, account information, and personal identification numbers (PINs) have been used as tools to authenticate a meter and to authorize a data transfer between a meter and a remote site.

The system is vulnerable, if, for example, the password is transmitted in unencrypted state to a remote processing location. An adversary monitoring the transmission lines or other channel of communication could intercept the password, and using this information, be able to gain unauthorized access to the meter's account. Moreover, conventionally, a PC can emulate a remote meter presenting fraudulent billing data; this will become a greater problem as more meters implement open standards such ANSI C12. Furthermore, many meters using proprietary protocols today are vulnerable to reverse engineering that provides enough information to create imposters.

Currently, energy meters are designed with trusted Point to Point (PTP) connectivity. Traditionally, telephone-line based PTP systems are assumed to be trustworthy since individual packets of data all follow the same route and are received in the order in which they were transmitted. However, packet-switched public data networks are supplanting traditional circuit-switched telephone networks as the main communication infrastructure. In a packet-switched public network, the network cannot be guaranteed to be reliable and secure for data transmission. It is possible, with packet-switched networks, to re-route packets through a third party without the knowledge of the other parties involved. This makes authenticating the data received at either end crucial to maintaining confidence in the data. Additionally, a third party intruder could intercept packets, modify billing data, and recalculate the packets' CRCs (along with other protocol requirements), and neither end of the link could detect it. This is possible because the protocols are public or can be reverse engineered, and the protocol and the data are all that is required to produce valid packets.

Thus, once a meter transmits the data, conventional meters cannot prohibit modifications to the data by a third party. U.S. patent application Ser. No. 09/729,179 describes a metering device that can digitally sign, and optionally encrypt, its data before transmitting it, thus enabling authentication by the intended receiver and allowing for secure transmission of that data. Automated Meter Reading (AMR) systems that collect, store, or analyze metered data must also transmit this data to its ultimate recipient (a billing system, for example). With traditional AMR systems, same tactics used to intercept and modify metered data between the meter and the AMR system could be used to intercept and modify, secretly, the metered data coming out of the AMR system. The AMR system may add value to the metered data by providing validation, estimation, or analysis data supplemental to the metered data. This supplemental data may also be subject to tampering during transmission over an untrusted public network.

Therefore, there is a need to secure and authenticate meter and energy data produced by the meter, and supplemental data produced by the AMR system, that is transferred between the AMR system and a remote site.

### SUMMARY OF THE INVENTION

The present invention is directed to systems and methods for digitally signing meter data to be transmitted from a data collection system to a recipient. A method provides for receiving digitally signed meter data from an energy meter; storing the digitally signed meter data at the data collection system; encrypting the digitally signed meter data using a public key of the recipient; and signing the encrypted digitally signed meter data using a private key of a data collection system.

In accordance with a feature of the invention, the method may include publishing the encrypted digitally signed meter data via a first untrusted network. Receiving digitally signed data may be performed over a second untrusted network. The first and second untrusted network may be the Internet.

The present invention helps to insure the validity of the data by signing the meter data.

According to another aspect of the invention, there is provided a data collection system for receiving digitally signed meter data. The system includes a microprocessor, a memory coupled to the microprocessor, a public key stored in the memory that is associated with an intended recipient of the signed meter data; and a private key stored in the memory for signing the digitally signed meter data for publication to the intended recipient.

According to another aspect of the invention, there is provided a method for receiving digitally signing meter data from a data collection system. The method includes receiving the digitally signed meter data by a recipient; retrieving a public key of the data collection system; verifying the digitally signed meter data using the public key; and decrypting the digitally signed meter data using a private key of the recipient.

The foregoing and other aspects of the present invention will become apparent from the following detailed description of the invention when considered in conjunction with the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of a system for securing data to be transmitted from a meter to a remote site;

FIG. 2 is a block diagram of a system incorporating a trusted directory where a corresponding public key and a meter's serial number is published;

FIG. 3 illustrates an exemplary structure of a common data collection system for collecting data from meters via untrusted networks to guarantee the data integrity, authenticity and security of the collected data; and

FIG. 4 shows the steps involved in collecting and publishing signed digital data from a meter that also signs its data.

### DETAILED DESCRIPTION OF ILLUSTRATIVE EMBODIMENTS

The invention is a method for applying public key infrastructure (PKI) technologies to the data it collects and produces. The invention may be implemented in a data collection server, such as the EnergyAxis Metering Automation Server, available from Elster Electricity, LLC.

Commonly assigned U.S. patent application Ser. No. 09/729,179 is directed to the application of digital signatures to metered energy data. A private key is used to sign the data, and the public key is used to authenticate it. This means that the public keys can be distributed to consumers of signed data, and only the producers of signed data (the meters) know the private keys. A characteristic of PKI is that each utility's private key (required to decrypt the data) is never distributed outside the utility, even to the server systems. Using PKI, two entities only need each other's public keys to authenticate each other's data. In other words, digital signatures use a secret private key to construct an authentication code in addition to the protocol and the data. Because the private key is never transmitted, the meter's signature can never be reproduced. Any modification of signed data will be detected.

More particularly, a level of secure interaction between a programmable electronic energy meter and a remote site or processing location involves the use of digital signatures using public key cryptographic algorithms consisting of a public key and a private key. The data generated by the meter is encrypted and signed by the meter and then transmitted to the remote site. The meter preferably comprises a REX Meter, Alpha Power+Meter or Alpha Meter manufactured by Elster Electricity, LLC.

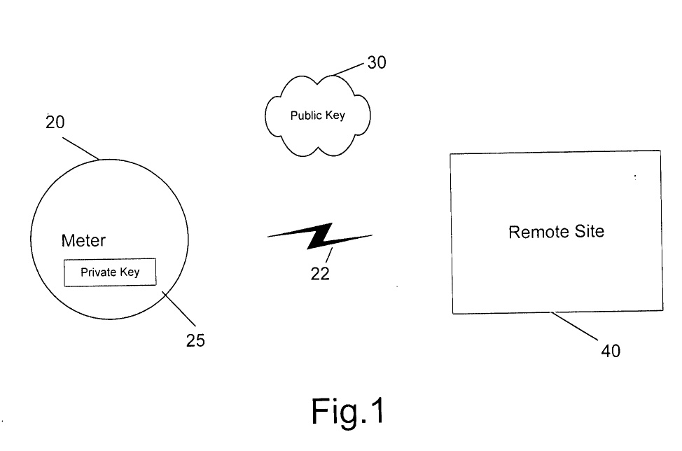

FIG. 1 is a block diagram of a system for securing data to be transmitted from a meter to a remote site. A meter 20 has a globally unique digital signature, the private key 25 of which is stored in the meter 20 and preferably does not change throughout the life of the meter. The private key 25 of the signature resides only within the meter, while the public key 30 of the signature is widely available, perhaps via trusted Internet directory servers.

Each meter 20 can have a microprocessor (along with memory) and a communications board which when coupled to a conventional modem permits the meter 30 to transmit and receive messages over a communication channel, such as an unsecured communication channel 22. In this manner, communications between a meter 20 and a remote site 40 may take place. The remote site preferably has a microprocessor along with a memory, or other computing device (e.g., a PC) coupled to a communications board and a modem, for example, for receiving the data from the communications channel and processing the data, as described herein, to authenticate the data.

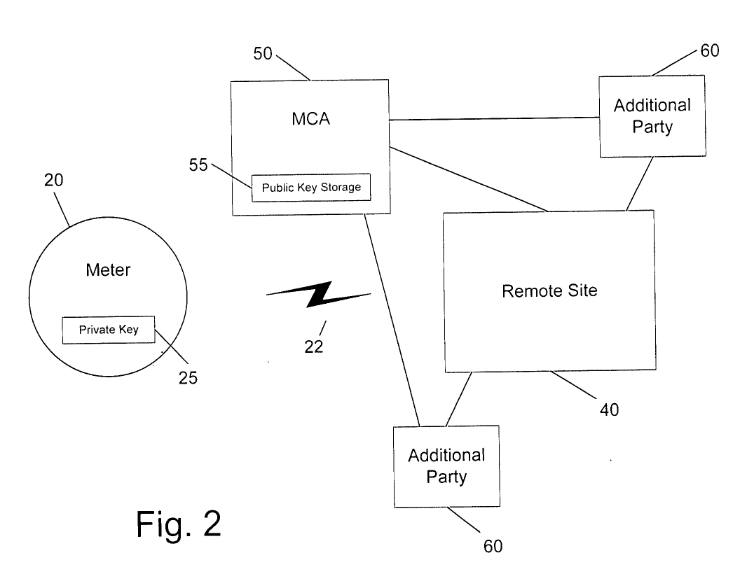

FIG. 2 is a block diagram of a system incorporating a trusted directory where the corresponding public key 30, along with the meter's serial number, is published for download by anyone. It is contemplated that the directory is operated by a trusted authority, such as a Metering Certificate Authority (MCA) 50. The MCA 50 has a public key storage or memory 55 that is a repository for the public keys. The MCA 50 can be, for example, a neutral industry organization providing, on a fee-for-service basis, the public keys for meters and the authentication of metered energy data. That is, given some digitally signed energy data, the MCA 50 will certify that the identity of the signer and that the data has not been altered after signing. Alternatively, the interested party may obtain the public key from the MCA 50 and perform the publicly documented verification process. Since the MCA 50 is a mutually trusted neutral third party, parties involved in the exchange of metered energy data can trust the MCA in lieu of trusting each other.

Upon receipt of signed energy data, the remote site 40 contacts the MCA 50, submits the data for authentication, and accepts or rejects the data based on the recommendations of the MCA 50. After authenticating the data, the remote site 40 may store or transmit the data, along with its signature, to other consumers 60, who can each contact the MCA 50 to authenticate the data individually. In this way, signed energy data can be exchanged confidently among interested parties.

By using digital signatures, the meter 20 can retain control over the data it produces and any modification of the data can be detected. Because the signature accompanies the data, and because a neutral third party (the MCA 50) certifies the data's authenticity, a consumer 60 of that data will know that they have the correct data. By using a neutral third party to authenticate signed meter data, mutually untrusting business entities can exchange meter data with high confidence. Furthermore, using a neutral third party to authenticate signed meter data allows transmission of that data via untrusted public data networks without losing the ability to verify authenticity.

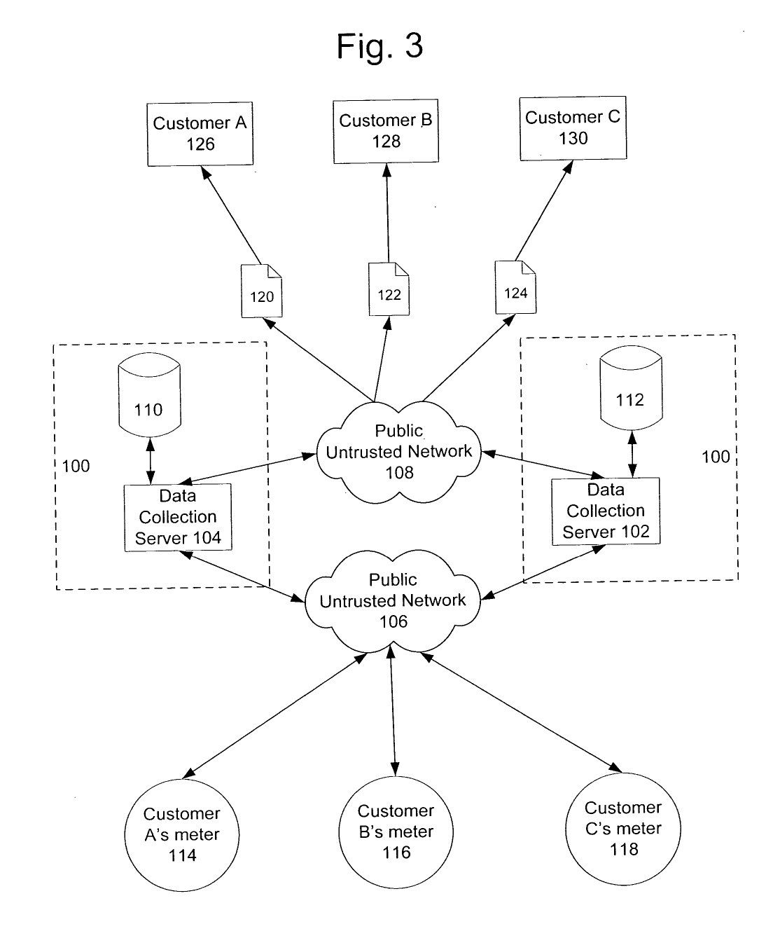

Referring now to FIG. 3, the present invention improves upon existing methods of securing data in a meter reading network. In particular, the present invention provides methods for using a common data collection system 100 to securely collect and publish data on behalf of multiple, possibly competing, business entities while guaranteeing that one entity's data is not accessible by another. An exemplary system 100 includes one or more data collection servers 102/104 and data repositories 110/112 that store data collected from meters 114, 116 and 118.

Before the data is transmitted by the meters 114, 116 and 118, the collected data is encrypted and signed by each transmitting meter. This is because the data may be transmitted over an untrusted network 106 to the data collection servers 102/104. After receiving the data, the servers 102/104 encrypt the collected data using a public key of an intended recipient and stores the data in the repository 110/112.

When the collected data is to be communication to the intended recipient (e.g., customers 126, 128 and 130), it is signed by the system 100 and communicated as published data 120, 122, 124. The data may be communicated over an untrusted network 108. The use of encryption and digital signatures allows the system 100 to assure the integrity of the collected data even after the data has been communicated from the system (i.e., been published externally). It is noted that the signing of the data by the system 100 maybe done using a certificate issued by a neutral certification authority.

The common data collection system 100 can be implemented on one or more computing devices, such as a conventional server running WINDOWS SERVER 2003, LINUX, etc. The system 100 can be hosted by a trusted third party as opposed to having to be owned and operated by a utility. As described below, the system 100 can collect data for multiple utilities, while ensuring security of data. The utility's trust relationship with the common data collection system owner/operator can be extended to the data collected by the system because the system can sign data in such a way as to make modifications (tampering or corruption) evident.

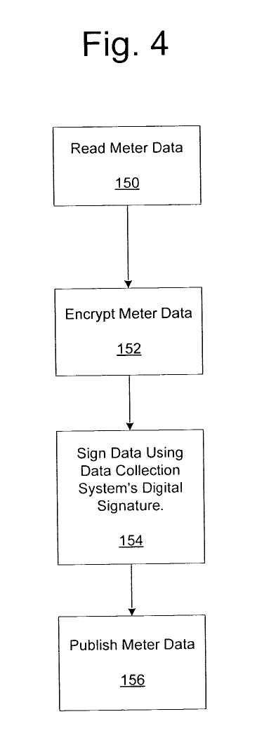

Specifically, with reference to FIG. 4, the common data collection system 100 implementing the invention may perform the following steps. At step 150, meter data is read from a collection of meters on behalf of one or more customers. Typically, the consumer of the data is the utility that is generating revenue from the metered information and each utility will own a collection of meters that the system will read for the utility.

At step 152, the meter data is encrypted and stored before publishing using the public key of the intended consumer of the data. This makes the data unintelligible to other parties involved in its transmission or storage. In the case where the system 100 is serving multiple, possibly competing utilities, the customer-specific encryption ensures that meter data is only usable by the intended utility and prevents the use of the data if it is accidentally delivered to an entity other than the intended consumer. Using PKI, only the public key is required to be on the data server 102/104, so even if the security of the server is compromised (for example by another utility) the data can not be decrypted and stolen.

At step 154, the data is signed using data collection system's digital signature. This allows consumers of the data to detect cases when the data has been altered from its original form during storage or transmission, or when it has been intentionally altered for purposes of tampering. In the case where the data, after collection and, optionally, encryption, is transferred via public untrusted networks, digital signing allows the receiver of the data to verify that the data has not been modified since being signed by the data collection system.

The signature is preferably bound to the data collection system 100 (or system owner) by using a certificate from a well-known certificate authority. This allows the consumer of the data to verify that the data comes from a trusted source (the data collection system) and allows detection of imposters. The certificate allows the data collection system (or owner, or the system software manufacturer) to vouch for the integrity of the data. The data collection system can ensure that the data has been faithfully interpreted, scaled, labeled, etc. and can be sure that consumers of the data can verify that the data originated from the server.

Finally, at step 156, the meter data is published from a utility's meters to the utility in a format appropriate for the utility.

A feature of the present invention is that it provides an environment in which a “hosting” type deployment provides for collection of data from meters owned by competing utilities. The host publishes the collected data in an encrypted format that only the intended recipient can decrypt. This allows, for example, storage of several utilities' data on the same server (in the encrypted format).

In addition, the system can certify meter data (according to regulatory or other standards) and ensure that any alterations to this certification can be detected. This is important in areas (such as load profiling) where significant interpretation of the raw data is required to give accurate billing data.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed:

1. A method for digitally signing meter data to be transmitted from a data collection system to a recipient, comprising:
receiving digitally signed meter data from an energy meter;
storing the digitally signed meter data at the data collection system;
encrypting the digitally signed meter data using a public key of the recipient; and
signing the encrypted digitally signed meter data using a private key of a data collection system.

2. The method according to claim 1, further comprising publishing the encrypted digitally signed meter data via a first untrusted network.

3. The method according to claim 2, said receiving digitally signed data being performed over a second untrusted network.

4. The method of claim 3, wherein the first and second untrusted network comprises the Internet.

5. The method of claim 1, wherein the validity of encrypted digitally signed meter data is guaranteed by signing the encrypted digitally signed meter data.

6. A data collection system for receiving digitally signed meter data, comprising:
a microprocessor;
a memory coupled to the microprocessor;
a public key stored in the memory that is associated with an intended recipient of the signed meter data; and
a private key stored in the memory for signing the digitally signed meter data for publication to the intended recipient.

7. The system according to claim 6, wherein when the digitally signed meter data is to be published to the intended recipient, the digitally signed meter data is encrypted by the public key and then signed by the private key.

8. The system according to claim 7, wherein the digitally signed meter data is communicated via untrusted networks.

9. The system according to claim 6, wherein the system is hosted by a third-party, and wherein the third-party aggregates meter data for more than one intended recipient.

10. The system according to claim 9, wherein the system comprises a plurality of public keys, each of the public keys being associated with a unique intended recipient.

11. The system of claim 6, wherein the validity of encrypted digitally signed meter data is guaranteed by signing the encrypted digitally signed meter data

12. A method for receiving digitally signing meter data from a data collection system, comprising:
receiving the digitally signed meter data by a recipient;
retrieving a public key of the data collection system;
verifying the digitally signed meter data using the public key; and
decrypting the digitally signed meter data using a private key of the recipient.
